(19) United States
(12) Patent Application Publication
(10) Pub. No.: US 2026/0318126 A1
(43) Pub. Date: Oct. 15, 2026

(54) MOTOR VEHICLE LOCK, IN PARTICULAR MOTOR VEHICLE DOOR LOCK

(71) Applicant: Kiekert Aktiengesellschaft, Heiligenhaus (DE)

(72) Inventor: Martin KREJCÍ, Zlunice (CZ)

(73) Assignee: Kiekert Aktiengesellschaft, Heiligenhaus (DE)

(21) Appl. No.: 19/481,228

(22) PCT Filed: Apr. 4, 2024
(86) PCT No.: PCT/DE2024/100274

§ 371 Date: Nov. 4, 2025

(30) Foreign Application Priority Data
May 4, 2023 (DE) 10 2023 111 545.6

(51) Int. Cl. E05B 81/90; E05B 79/20; E05B 81/04; E05B 81/14

(52) U.S. Cl. CPC E05B 81/90; E05B 79/20; E05B 81/04; E05B 81/14

(57) ABSTRACT

A motor vehicle lock and in particular to a motor vehicle door lock and preferably a motor vehicle tailgate lock. Said lock is formed with a locking mechanism comprising substantially a rotary latch and a pawl as locking elements. Moreover, an actuating lever chain for acting on the locking mechanism is provided. At least one actuating lever of the actuating lever chain and/or a locking elemen of the locking mechanism has a releasable attachment for a connecting means to, for example, a handle or an electromotive drive and additionally to a spring. According to the invention, one end of the spring engages captively in a closed spring eye of the actuating lever and/or of the locking element.

The invention relates to a motor vehicle lock, in particular to a motor vehicle door lock, preferably a tailgate lock, having a locking mechanism consisting substantially of a rotary latch and a pawl as locking elements, and having an actuating lever chain for acting on the locking mechanism, wherein at least one actuating lever of the actuating lever chain and/or a locking element of the locking mechanism has a releasable attachment for a connecting means to, for example, a handle or an electromotive drive and additionally a spring.

A motor vehicle lock and in particular a motor vehicle door lock in the embodiment as a tailgate lock of the embodiment described above has become known through DE 10 2011 114 148A1. At this point, the locking pawl is actuated by a helical spring. Furthermore, a Bowden cable is detachably connected to the locking pawl. This allows the pawl to be moved into its open position via the connected Bowden cable, thereby releasing the rotary latch. Such a procedure is generally advantageous, for example, in the case of tailgate locks or motor vehicle tailgate locks, when it comes to opening the associated motor vehicle tailgate, for example, from the interior of a luggage compartment.

In fact, such tailgate locks are usually equipped with an external handle and an electromotive drive for closing. With the aid of the electromotive drive, the tailgate lock in question, or motor vehicle tailgate lock, can be moved into the main ratchet position after a pre-ratchet position has been reached manually. This is generally known.

To open such a motor vehicle tailgate lock from the inside, for example in connection with an emergency opening or emergency unlock, an inside handle is provided, which is sometimes concealed, but in any case has a certain distance from the tailgate lock. This gap is bridged using the connecting means, so that the tailgate lock in question can be (emergency-) opened or (emergency-) unlocked by the handle.

Naturally, the invention also includes conventional motor vehicle locks and, in particular, motor vehicle door locks for, for example, motor vehicle side doors. In this case, a spring-loaded internal actuating lever and/or an external actuating lever can also be used, additionally having an attachment for a connecting means and in particular a flexible connecting means. Any gaps between the handle and the motor vehicle lock are bridged by the connecting means. In principle, instead of using a handle, an electromotive drive can also be used to actuate the connecting means and then to provide the described unlocking or opening of the vehicle lock by mechanical or electromotive means. In addition, it is also possible to directly actuate a locking element, for example the pawl, using the handle or the electromotive drive and the connecting means, and to lift it from its engagement with the rotary latch.

The attachment of the connecting means to the locking element and/or the actuating lever often takes place during the installation of the motor vehicle lock in the corresponding vehicle door, which nowadays typically occurs on an assembly line in an automobile factory. The handle may have been mounted beforehand. The general problem with this assembly process is that when the connecting means is attached to the actuating lever and/or the locking element, the spring acting on the lever or the locking element in question is damaged or—even worse—stripped off. Such a functional impairment of the spring often only becomes noticeable after years of operation, following assembly and the installation of covers.

This can be attributed to the fact that the effect of the spring only really becomes important after a certain operating time, namely when, for example, a Bowden cable as a connecting means shows signs of fatigue or elongation.

A malfunction in a handle for emergency unlocking or emergency opening of, for example, a vehicle tailgate, is certainly not observed during normal operation, but only when the tailgate in question is to be opened from the inside in an emergency. Otherwise, such a tailgate is usually unlocked electrically and then opened via the external handle. This means that the inside handle and the associated actuating lever are only used in emergencies. This must be avoided—i.e., functional impairments must be ruled out in an emergency.

The invention is therefore based on the technical problem of further developing such a motor vehicle lock and in particular a motor vehicle door lock in such a way that flawless functionality of the spring is ensured, which is not impaired by the installation or removal or generally by manipulation of the attachment for the connecting means.

To solve this technical problem, a generic motor vehicle lock, and in particular a motor vehicle door lock, is characterized in that the spring engages with one end in a captive manner in a closed spring eye of the actuating lever and/or locking element.

In contrast to the prior art, as it is realized and implemented in practice, the closed spring eye on the actuating lever and/or locking element ensures that the end of the spring engaging in the spring eye is not accidentally stripped off the actuating lever and/or locking element in question, for example during the assembly of the connecting means at the releasable attachment, or otherwise removed from the actuating lever and/or locking element in question. This also prevents damage to the spring. Rather, the closed spring eye ensures that assembly movements of the connecting means cannot reach the end of the spring engaging in the closed spring eye, and as a result of this assembly, previously observed possible functional impairments due to the detached spring no longer occur in practice. These are the main advantages.

According to an advantageous embodiment, the spring is designed as a return spring. That is, the spring ensures that the actuating lever or the locking element, after being actuated by the handle or the electromotive drive in the example case, is moved back to its unactuated starting position. For this purpose, the spring is typically designed as a leg spring with a fixed leg connected to a lock housing and a loose leg engaging in the spring eye. The fixed leg and the loose leg of the leg spring are coupled to each other via a coil section.

In a further advantageous embodiment, the coil section of the leg spring is mounted on a pin. This makes assembling the spring easier. This is important because typically the spring and the actuating lever or the locking element protrude at least partially from the lock housing in order to be able to carry out the described assembly process on site in the car factory.

This means that both the spring eye and the attachment for the connecting means of the actuating lever and/or the locking element are usually oriented in such a way that they are located outside the lock housing, so that the connecting means can be attached without any problems. This also makes it easy and practical to attach the spring to the corresponding actuating lever and/or locking element, even with the lock housing already installed.

The coil section for coupling the fixed leg and the loose leg of the leg spring is attached to the aforementioned pin for easy installation of the leg spring. To ensure that the leg spring and/or coil section is held captively on the pin during this process, an axial stop extending over the entire coil section is provided on the pin. This axial stop is usually found on the head side of the pin. In addition, it has proven to be particularly advantageous in this context if the pin is designed as a component of the lock housing.

In fact, the lock housing, or at least a lock cover of the lock housing, is generally made of plastic or manufactured as a plastic injection molded part. This allows the pin to be produced directly and automatically as an integral part of the plastic housing. The same applies to the axial stop.

To ensure that the spring is properly secured to the spring eye, the spring is bent back at the end that engages the spring eye. In most cases, the invention uses a variant at this point such that the end of the spring in question, which engages in the spring eye, is bent back in a U-shape. This ensures that the corresponding end of the spring or leg spring, which engages in the spring eye, is held securely and captively in the spring eye. This applies even if the bent end of the spring is subjected to pressure, for example, when attaching the connecting means to the attachment of the actuating lever and/or locking element.

The previously mentioned releasable attachment for the connecting means is usually designed as a hook eyelet for the Bowden cable or a coupling rod. For this purpose, for example, one core of the Bowden cable has a hook that is inserted into the hook eyelet for the releasable coupling. Similarly, the coupling rod may also be equipped with a corresponding hook for engaging in the hook eyelet.

The hook eyelet and the spring eye are typically formed on an actuating lever arm of the actuating lever and/or locking element. The actuating lever arm in question is located at least partially outside the lock housing. This allows the spring, as well as the attachment of the connecting element, to be installed even when the motor vehicle lock is installed.

The actuating lever is generally an internal actuating lever. The internal actuating lever is usually used for emergency unlocking or emergency opening. Of course, this only applies as an example and is in no way to be understood as restrictive. Such an emergency unlocking or emergency opening is particularly recommended if the motor vehicle lock is a motor vehicle tailgate lock. This has already been explained in the introduction.

The invention is explained in greater detail below with reference to drawings which show only one exemplary embodiment. In the drawings:

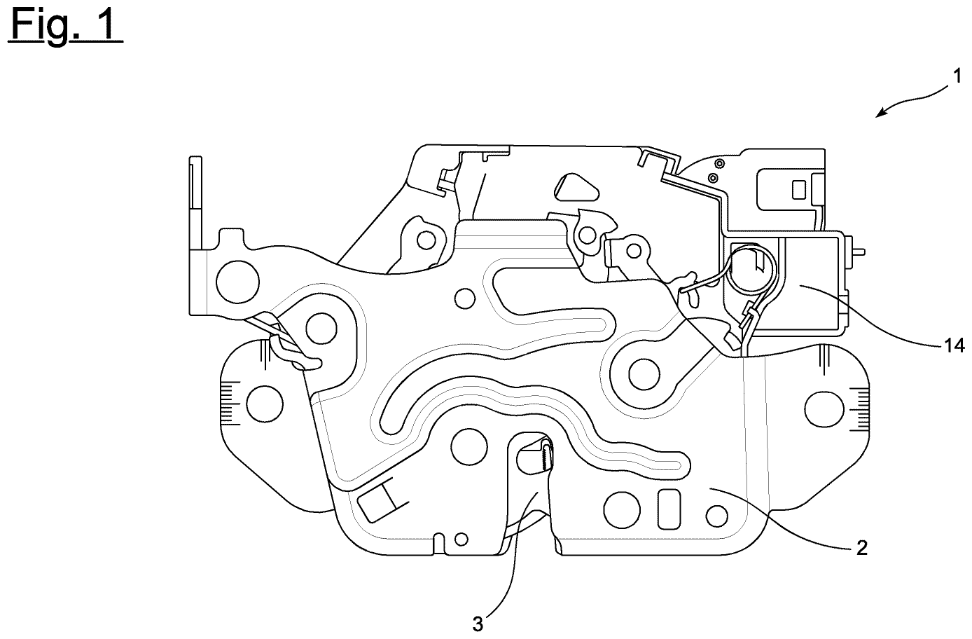

FIG. 1 shows a basic overview of the motor vehicle lock,

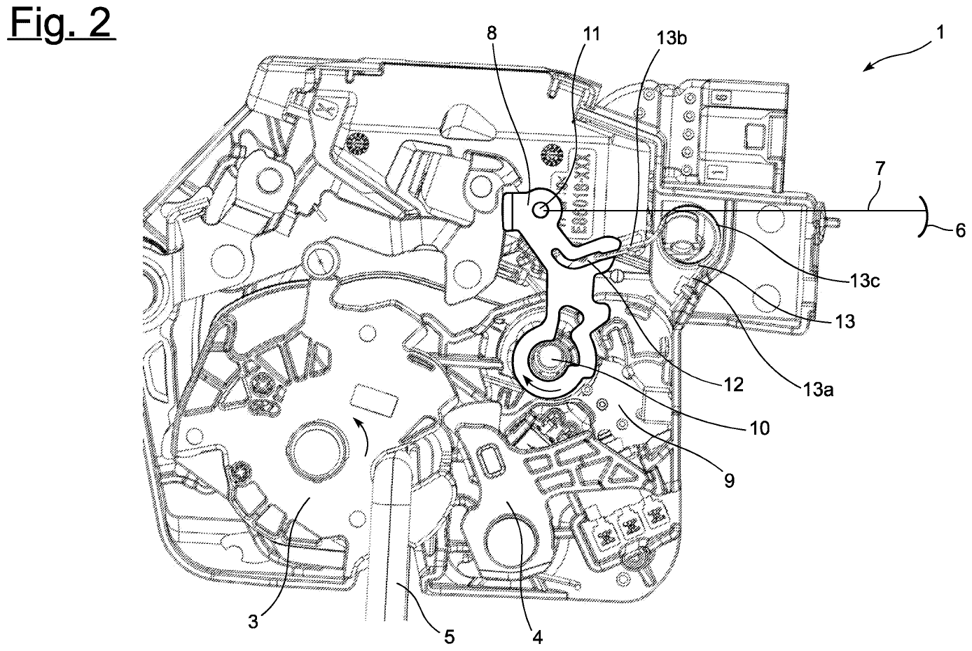

FIG. 2 shows the motor vehicle lock according to FIG. 1 with the lock housing removed, and

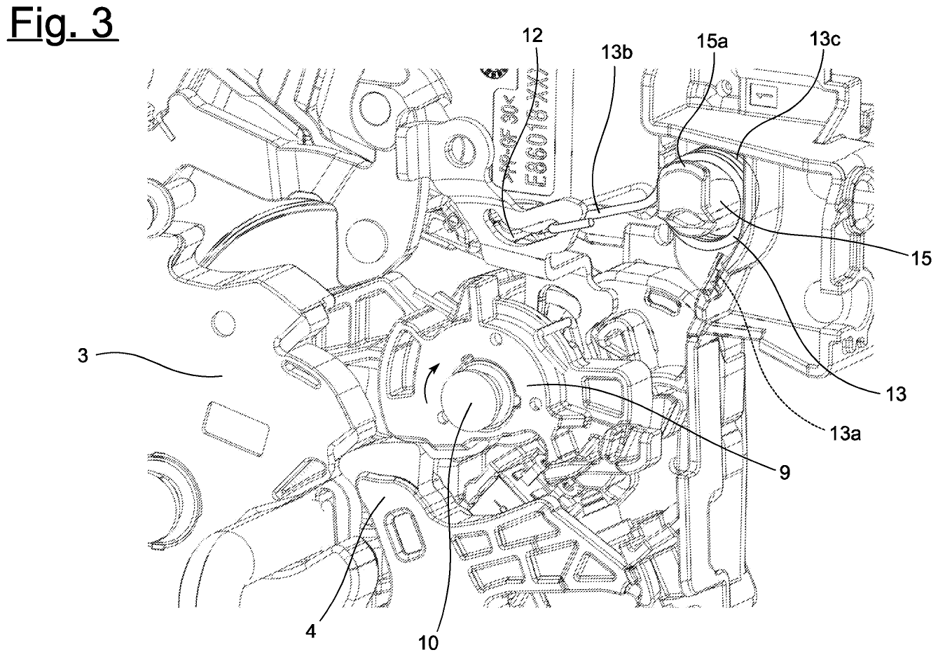

FIG. 3 shows a different view of the subject matter of FIG. 2.

The figures show a motor vehicle lock and in particular a motor vehicle door lock. Specifically, the motor vehicle lock in question is a motor vehicle tailgate lock and/or tailgate lock 1. This can be mounted on the edge of a motor vehicle tailgate, which is not explicitly shown. According to the embodiment, the tailgate lock 1 has a lock plate 2 which serves for the rotatable mounting of a locking mechanism 3, 4, which can be seen in particular in FIGS. 2 and 3, consisting substantially of a rotary latch 3 and a pawl 4. The locking mechanism 3, 4 holds a locking bolt or latch holder 5 captive, which can be seen in FIGS. 2 and 3. This corresponds to the main ratchet position of the locking mechanism 3, 4 shown in FIGS. 2 and 3.

In addition to this main ratchet position, the locking mechanism 3, 4 can also assume a pre-ratchet position. Once this is the case, typically a closing drive (not explicitly shown) acting on the rotary latch 3 ensures that the rotary latch 3 is pivoted counterclockwise from the pre-ratchet position as indicated in FIG. 2, until the pawl 4 engages in the main ratchet visible in FIG. 2 and thereby defines the main ratchet position. This captures the locking bolt or latch holder 5 and locks the corresponding vehicle tailgate.

Since the locking or the described closing process of the embodiment is generally carried out electromechanically using the closing drive, the motor vehicle tailgate usually does not have an inside handle. In contrast, an external handle has been implemented. Instead of the internal handle, an emergency operating handle is often used. This is of course only an example and applies to the tailgate lock shown (1). In the case of a motor vehicle side door lock, the inside handle and the outside handle are usually implemented independently of each other.

Either way, one can recognize in the figures an implied handle 6, which may be designed as an inside handle 6. In order to transmit the forces acting on this inside handle to an actuating lever 8 shown in the figures as part of an actuating lever chain 8, 9, a connecting means 7 is provided. The connecting means 7 may be a coupling rod.

According to the embodiment shown, the connecting means 7 is designed to be flexible and is specifically a Bowden cable or cable pull. With the aid of the handle 6 and the connecting means 7, the actuating lever 8, designed as a pivot lever pivotable about an axis 10, can perform a clockwise movement as indicated in FIG. 2.

This clockwise movement of the actuating lever 8 results in a coaxially mounted release lever 9, as a further component of the actuating lever chain 8, 9, also being pivoted clockwise, as indicated in FIG. 3. This releases the pawl 4 from its latching engagement with the rotary latch 3 and allows the rotary latch 3 to pivot clockwise, contrary to its counterclockwise closing movement shown in FIG. 2, under spring pressure. This releases the locking bolt and/or latch holder 5 and allows the corresponding tailgate to be swung open.

The connecting means 7 is connected to the actuating lever 8 via a releasable attachment 11. According to the embodiment, this releasable attachment 11 for the connecting means 7 manifests itself as a hook eyelet 11 for the Bowden cable 7 realized at this point. In fact, for this purpose the Bowden cable 7 has a core that can be moved back and forth inside a sheath, which is equipped with a corresponding hook on the end facing the lever, and engages with this hook in the hook eyelet 11. The releasable attachment of the Bowden cable is typically carried out in connection with an assembly process that typically follows the assembly of the illustrated motor vehicle lock and the handle 6.

That is, the connecting means 7 is releasably coupled to the hook eyelet 11 after the tailgate lock 1 has been installed in the tailgate in the example case. To make this possible, the hook eyelet 11 in question and a closed spring eye 12 realized according to the invention are each located outside a lock housing 2, 14, which can be seen in particular in FIG. 1. The lock housing 2, 14 consists on the one hand of the metallic lock case or lock plate 2 for mounting the locking mechanism 3, 4 and on the other hand of a lock cover 14 made of plastic.

The actuating lever 8 is pre-tensioned by means of a spring 13. In the embodiment, the spring 13 is a return spring which acts on the actuating lever 8 in the direction opposite to its action to open the locking mechanism 3, 4, consequently in a counterclockwise direction according to the embodiment, because the opening of the locking mechanism 3, 4 corresponds to a clockwise rotation of the actuating lever 8 about its axis 10 (see the arrow in FIG. 2). For this purpose, according to the embodiment, the spring 13 is designed not only as a return spring, but specifically as a leg spring with a fixed leg 13a, loose leg 13b and an interposed coil section 13c.

The fixed leg 13a of the leg spring 13 is connected to the lock housing 2, 14 and specifically to the lock cover 14. In contrast, the loose leg 13b of the leg spring 13 engages in the already mentioned closed spring eye 12 on the actuating lever 8. This ensures that the spring 13 engages with one end, specifically with the end of the loose leg 13b, in the spring eye 12 of the actuating lever 8.

The leg spring 13 is installed by placing its coil section 13c onto a pin 15. This pin 15 is provided on the lock housing 2, 14 and specifically on the lock cover 14 and, according to the embodiment, represents an integral part of the lock cover 14. Furthermore, the pin 15 has an axial stop 15a on its head end. In this way it is ensured that the coil section 13c of the spring 13 is held practically captively on the pin 15 and cannot, for example, be stripped off by an axial movement along the pin 15.

It can be seen that the spring 13 is bent back with its end engaging in the spring eye 12. Specifically, the end of the spring 13 in question is bent back in a U-shape. This U-shaped, recurved end is found on the loose leg 13b of the leg spring 13. The U-shaped design at the end of the loose leg 13b of the leg spring 13 ensures that the loose leg 13b of the leg spring 13, and thus the leg spring 13 as a whole, is held captively in the spring eye 12.

It can be seen that the spring eye 12 is designed overall with an arcuate form. This arcuate form of the spring eye 12 takes into account the fact that when the actuating lever 8 is actuated by means of the handle 6, via the intermediate connecting means 7, it performs the pivoting movement shown in FIG. 2 in a clockwise direction around the axis 10 to open the locking mechanism 3,4. This allows the U-shaped bent end of the loose leg 13b of the leg spring 13 to move along the arcuate and specifically concave spring eye 12 during the pivoting movement in question of the spring eye 12, and still ensures that the required spring force for resetting the actuating lever 8 is exerted in a counterclockwise direction on the actuating lever 8 via the loose leg 13b.

As already explained, the actuating lever 8 can be an internal actuating lever and in particular one with which an emergency actuation/emergency unlocking of the motor vehicle lock and specifically of the tailgate lock 1 is achieved and possible. For this purpose, the handle 6 may be arranged behind or in a panel of the tailgate (not shown). Of course, this only applies as an example. This is because, instead of the handle 6, an electromotive drive can also be used at this position for acting on the connecting means 7 and thus the actuating lever 8.

### LIST OF REFERENCE SIGNS:

1 tailgate lock
2 lock plate
3, 4 locking mechanism
5 locking bolt, latch holder
6 handle, inside handle
7 connecting means
8 actuating lever
8, 9 actuating lever chain
10 axis
11 attachment, hook eyelet
12 spring eyelet
13 Spring
13a fixed leg
13b loose leg
13c coil section
14 lock cover
15 pin
15a axial stop

1. A motor vehicle lock, in particular motor vehicle door lock, preferably motor vehicle tailgate lock, having a locking mechanism consisting substantially of a rotary latch and a pawl as locking elements, and having an actuating lever chain for acting on the locking mechanism, wherein at least one actuating lever of the actuating lever chain and/or a locking element of the locking mechanism has a releasable attachment for a connecting means to, for example, a handle or an electromotive drive, and additionally a spring,
wherein
one end of the spring engages captively in a closed spring eye of the actuating lever and/or locking element.

2. The motor vehicle lock according to claim 1, wherein the spring is designed as a return spring.

3. The motor vehicle lock according to claim 1, wherein the spring is designed as a leg spring with a fixed leg connected to a lock housing and a loose leg engaging in the spring eye.

4. The motor vehicle lock according to claim 3, wherein coil section of the leg spring is mounted on a pin.

5. The motor vehicle lock according to claim 4, wherein the pin has an axial stop which protrudes past the coil section.

6. The motor vehicle lock according to claim 1, wherein the spring is bent back at its end engaging in the spring eye.

7. The motor vehicle lock according to claim 6, wherein the end of the spring is bent back in a U-shape.

8. The motor vehicle lock according to claim 1, wherein the releasable attachment for the connecting means is designed as a hook eyelet for a Bowden cable or a coupling rod.

9. The motor vehicle lock according to claim 8, wherein the hook eyelet and the spring eye are provided on an actuating lever arm of the actuating lever.

10. The motor vehicle lock according to claim 1, wherein the actuating lever is designed as an internal actuating lever, in particular as an emergency actuating device/emergency unlock device.
